(19) United States
(12) Patent Application Publication
(10) Pub. No.: US 2009/0087280 A1
(43) Pub. Date: Apr. 2, 2009

(54) REUSEABLE LOCK NUT DEVICE

(76) Inventor: Travis L. Harnetiaux, Woodridge, IL (US)

Correspondence Address: CNH AMERICA LLC, INTELLECTUAL PROPERTY LAW DEPARTMENT, 700 STATE STREET, RACINE, WI, 53404, US

(21) Appl. No.: 11/865,335

(22) Filed: Oct. 1, 2007

(51) Int. Cl. F16B 39/00

(52) U.S. Cl. 411/436

(57) ABSTRACT

A reusable lock nut device is provided. The reusable lock nut device includes a nut with an axial bore and at least one setscrew bore extending radially through a sidewall and opening into the axial bore. The setscrew bore accepts a setscrew for interfacing with and selectively locking against a threaded fastener, used with the reusable lock nut device. The threads of the threaded fastener define a thread angle between respective pairs of converging lateral thread walls. An end portion of the setscrew is tapered, with a taper angle that corresponds to such thread angle. This configuration enables the end portion of the setscrew to nest wholly within a thread valley defined between walls segments of the respective pairs of converging lateral thread walls.

### FIELD OF THE INVENTION

The invention relates generally to hardware-type fasteners and, in particular, to a lock nut device that is reusable and is suitable for use with threaded hardware of a variety of sizes, including relatively large threaded hardware components.

### BACKGROUND OF THE INVENTION

When conventional bolt and nut fastener assemblies are used in high vibration operating environments, the conventional nuts can be urged into rotational movement which can reduce the clamping forces being applied by such fastener assemblies. The reduction in clamping forces can lead to numerous problems such as compromising the alignment of various components within a subassembly or assembly, and ultimately can contribute to failures of the various components. Such high vibration operating environments are common in numerous agricultural, industrial, and other applications.

In efforts to deal with non-desired loosening-type forces, various fasteners including “lock nuts” have been previously provided for use with, e.g., bolts or threaded shafts. In some implementations, castellated nuts or “castle nuts,” along with corresponding cotter pins, can be used. However, castle nuts and cotter pins require bores to be drilled radially through the threaded shaft or other corresponding component. This can weaken the threaded shaft or other corresponding component, as well as, add to the manufacturing costs of such component. Furthermore, castle nuts typically have a substantial amount of sidewall material removed to form the slots that provide the castellated appearance. This makes castle nuts generally ill suited for high torque applications.

Flange nuts have been widely used in certain applications. These nuts have flanges which radiate outwardly from their lower surfaces. The flanges are serrated on their bottom surfaces, whereby they dig and hold into the surfaces of the material they engage. Often, even after a single use, the serrated flanges can become battered, compromising their holding or locking effectiveness in subsequent uses.

Deforming lock nuts have also been used in certain applications. Such lock nuts have threads that deform when sufficiently tightened. Accordingly, when these lock nuts are tightened, the deformed threads of the lock nuts create an interference with the corresponding threads of the bolt or other threaded fastener. Since the threads are deformed during use, often such deforming lock nuts are unsuitable for multiple uses.

Other varieties of lock nuts use a nylon member as a locking portion. Such nylon lock nuts incorporate a nylon interference washer that is concentrically housed in the end of the lock nut. The nylon interference washer deforms during use to create a mechanical interference with the corresponding threads of the bolt or other threaded fastener. Subsequent uses of an individual nylon lock nut prove less effective than the initial use, because the nylon interference washer is unable to restore to its initial configuration.

Some attempts have been made to provide lock nuts which are suitable for multiple uses. These reusable lock nuts typically include a setscrew which threads radially through the side of the nut. However, reusable lock nuts with setscrews typically incorporate a solid and sometimes blunt surface at the end of the set screw. The blunt or solid end of the setscrew engages only a small portion of the threaded surface area of the bolt or other threaded fastener, e.g., the outer-most edge of the thread peak(s). As a result, the setscrew has a tendency to batter or otherwise damage the threads that it engages.

Accordingly, some lock nuts have a relatively short use life, sometimes only a single use. Other, set screw-type, lock nuts can be used multiple times but tend to damage the threads they engage.

### SUMMARY OF THE INVENTION

There is a need for reusable lock nuts in a variety of sizes, including those for use with very large bolts and shafts which are typically not accommodated by conventional locking type hardware. There is also a need for reusable lock nuts that can be used without compromising the integrity of the threads they engage on corresponding pieces of hardware or fasteners.

The present invention provides a lock nut device that meets the desires and needs described above, while being used, e.g., in combination with hardware of a variety of sizes, including relatively large sizes found in agricultural and industrial applications. In a first embodiment of the present invention, a lock nut device is provided for facilitating repeated use while mitigating the likelihood of damaging the threads of the bolt or other fastener on which the device is used. The device also provides a lock nut having an axial bore and at least one setscrew bore extending radially through a sidewall and opening into the axial bore. The setscrew bore can accept a setscrew for interfacing with and selectively locking against a threaded fastener extending through the axial bore.

It is contemplated for the setscrew to include a shank, a tool accepting end, and a thread engaging end. The thread engaging end tapers downwardly from its intersection with the shank, to a planar, optionally annular, end surface. The taper style can be, e.g., conical, so that the thread engaging end of the setscrew defines a frusto-conical outer surface.

A void or depression can extend axially into the end surface of the thread engaging end. The depression can be any of a variety of suitable configurations, including cylindrical, conical, or other voids, as desired.

In still further implementations, the taper of the thread engaging end defines a taper angle. This taper angle corresponds to, e.g., the configuration of threads on the outer circumferential surface of fasteners being used with the lock nut device. It is contemplated for the taper angle and/or the other characteristics of the setscrew thread engaging end to enable the setscrew to, as desired, loosely interface the threaded fastener so that the threaded fastener's treads easily encounter, slide across, and helically traverse, the setscrew. Furthermore, when it is desired to exploit the locking functionality of the lock nut device, the setscrews can be loaded by axially driving them relatively further into the thread valleys and interfacing the threads along a generally elongate contact patch, whereby the likelihood of damaging the threads by localized high pressure application is mitigated.

The setscrews can be actuated, locked and unlocked, i.e., loaded and unloaded, as desired. Since this cycle is repeatable as desired by the user, the lock nut device is capable of being reused multiple times.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 illustrates a detailed isometric view of a first embodiment of a reusable lock nut device in accordance with the present invention.

FIG. 2 illustrates an exploded isometric view of the reusable lock nut device shown in FIG. 1.

FIG. 3 illustrates a front elevation of the reusable lock nut device, shown in FIG. 1, being used with a threaded fastener.

FIG. 4 illustrates a cross-sectional view of the reusable lock nut device taken at line 4-4 of FIG. 3.

### DETAILED DESCRIPTION OF THE PREFERRED EMBODIMENTS

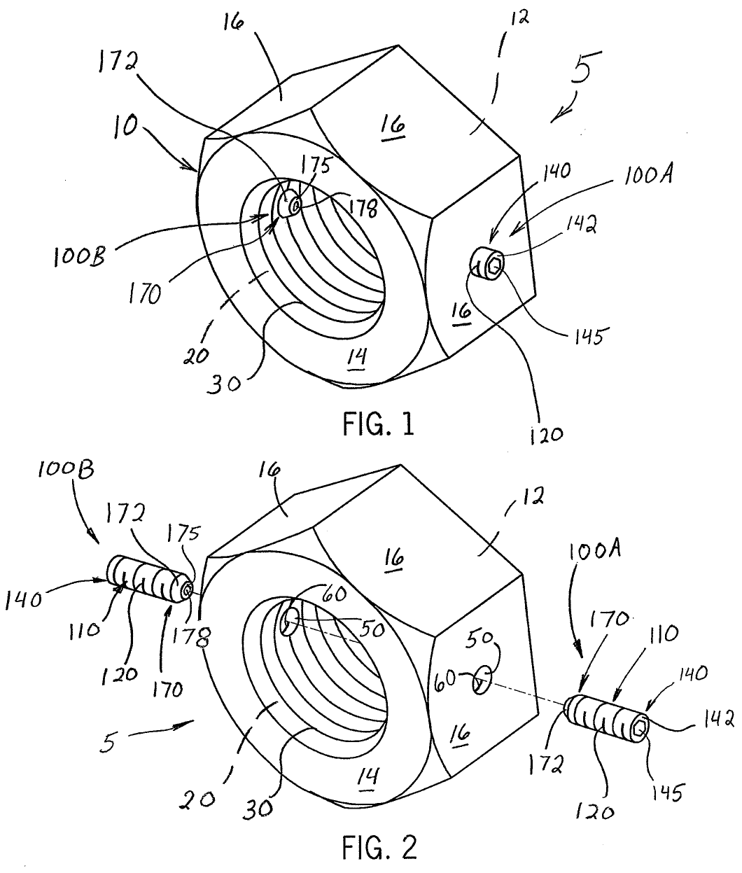

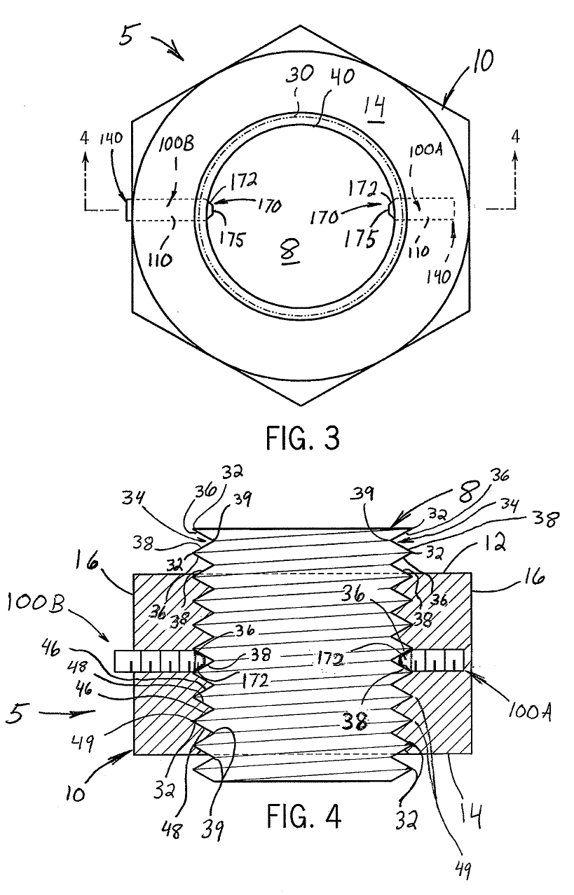

FIG. 1 shows a first embodiment of a reusable lock nut device; namely, lock nut device 5. Lock nut device 5 is adapted and configured for use with fastener 8 (FIGS. 3 and 4), to selectively and lockingly engage therewith, as desired by a user. The lock nut device 5 is also adapted and configured for multiple uses, e.g., multiple locking and unlocking engagement cycles or events. During such multiple or repeated uses, the integrity of the fastener 8 is substantially maintained, particularly at the portions which interface the locknut device 5.

Referring now to FIGS. 3 and 4, lock nut device 5 cooperates with fastener 8 which can be any of a variety of suitable fasteners and/or pieces of hardware, e.g., any of a variety of bolts, threaded rods, screws, and/or other suitable hardware or fasteners. Fastener 8 functions as the male threaded component of a hardware or fastener assembly, whereby nut 10 would be the female threaded components of the same assembly. Accordingly, threads 40, which extend from an outer circumferential surface of fastener 8, correspond in size, pitch, angle, profile, and configuration to those of nut 10.

Threads 30 of fastener 8 preferably correspond to any of the various standard thread configurations, including, e.g., various International Organization for Standardization (ISO) metric thread configurations; various British Standard Whitworth (BSW) thread configurations such as British Standard Fine (BSF), Cycle Engineers' Institute (CEI), and British standard pipe thread (BSP); various Unified Thread Standard (UTS) such as unified coarse (UNC), unified fine (UNF), unified extra fine (UNEF), unified special (UNS), and national pipe thread (NPT). Regardless of the particular thread configuration, the threads 30 of any faster 8 correspond to and suitably engage those of nut 10.

Accordingly, threads 30 define alternating thread peaks 32 and thread valleys 34. The thread peaks 32 are radially distal an axis of fastener 8, whereby they define the outermost extending portions of threads 30. Thread valleys 34 are radially proximate the axis of fastener 8 whereby they define the inner most portion of threads 30.

Thread valleys 34 of fastener 8 include first and second converging lateral wall segments 36, 38. Lateral wall segments 36, 38 join each other at a point of intersection 39 and extend angularly away from each from that point 39 toward respective adjacent peaks 32. Lateral wall segments 36, 38 can be substantially analogues and mirror images of each other. In this configuration, the wall segments 36, 38 have the same lengths and are positioned at the same angle with respect to a line extending normal to the outer circumferential surface of fastener 8, at the point of intersection 39, whereby the thread valleys 34 define a generally V-shaped profile. Accordingly, the angle between wall segments 36 and 38 can be about 60 degrees, optionally others, but in any regard corresponds in magnitude to that of the angle between wall segments 36 and 38 of fastener 8.

Referring now to FIGS. 1, 2, and 4, lock nut device 5 includes nut 10, and first and second setscrews 100A, 100B. Nut 10 is largely analogous to conventional nut-type hardware. It has first and second generally annular ends 12, 14 that define a length dimension therebetween. The outside perimeter of nut 10 is defined by multiple flat segments or sidewalls 16 that are angularly joined to each other and, in combination, form a polygonal configuration.

Bore 20 extends axially through the nut 10, between the first and second ends 12, 14. Threads 40 of bore 20 define a threaded inner circumferential surface of nut 10. The threads 40 of bore 20 correspond in size, pitch, angle, profile, and configuration to threads 30 upon fastener 8, whereby the fastener 8 and nut 10 cooperate as related fastener or hardware components.

Like threads 30, threads 40 of nut 10 preferably correspond to any of the various standard thread configurations. Also similar to threads 30, threads 40 define alternating thread peaks 42 and thread valleys 44. The thread peaks 42 are radially nearer an axis of nut 10 and further from a respective sidewall 16, whereby they extend relatively further into bore 20. Thread valleys 44 are radially further from the axis of nut 10 and nearer the sidewall 16, whereby they extend relatively less far into bore 20, as compared to peaks 42.

Thread valleys 44 of nut 10 include first and second converging lateral wall segments 46, 48. Such lateral wall segments 46, 48 join each other at a point of intersection 49 and extend angularly away from each other from the point of intersection 49 toward respective ones of adjacent peaks 42.

Lateral wall segments 46, 48 can be substantially analogues and mirror images of each other, as reflected about the point of intersection 49. In this configuration, the wall segments 46, 48 have the same lengths and are positioned at the same angle with respect to a line extending normal to the nut surface at the point of intersection 49, defining a V-shaped profile of threads valleys 44. Accordingly, as with some standard thread conventions, the angle between the wall segments 46 and 48 can be about 60 degrees, optionally others.

The distance between each of the sidewalls 16 and the bore 20 defines a sidewall thickness dimension of nut 10. At least one, preferably two or more, of the sidewalls 16 has a setscrew bore 50 extending therethrough. The setscrew bores 50 can extend through medial portions of sidewalls 16 and include threads 60 extending thereinto. The threads 60 of setscrew bores 50 enable the nut 10 to threadedly receive setscrews 100A, 100B, therein, as hereinafter described.

In some implementations, each setscrew bore 50 has a diameter which corresponds to, optionally can be generally equivalent to, the axial distance between adjacent peaks 42 and/or adjacent points of intersection 49 of valleys 44 within nut 10. In other implementations, the opening of the setscrew bore 50 at its intersection with bore 20 has a diameter that is generally equivalent to the axial distance between adjacent peaks 42 or valleys 44 within nut 10, while the remaining portion of setscrew bore 50 has a relatively greater diameter. In other words, in some implementations, the magnitude of the diameter of setscrew bore 50 approximates the width dimension of one whole thread width of threads 40. Threads of setscrew bore 50 are adapted, for receiving a corresponding setscrew 100A, 100B therein. The particular relationship between the diameter of the setscrew bore 50 and the diameter of the opening between it and bore 20 are selected based on the particular configuration and dimension of threads 30, 40, as well as, the configuration of the desired setscrews 100A, 100B.

Each of setscrews 100A, 100B is an elongate bolt or screw with a shank 110, a tool engaging end 140, and a thread engaging end 170. Shank 110 extends between the tool engaging end 140 and thread engaging end 170. It can have a substantially constant diameter along its length. An outer circumferential surface of shank 110 includes threads 120, which correspond to and are adapted to be received by the threads 60 of setscrew bore 50.

Preferably, setscrews 100A, 100B are capless or headless, e.g., of grub screw-type configuration, whereby the diameters of shanks 110 define the greatest diameter portions of the setscrews 100A, 100B. In such implementations, the setscrews 100A, 100B can be driven so that end surfaces 142 of the tool engaging ends 140 are seated flush with or below the surface (sub-flush) of the respective nut sidewall 16 into which they extend. As desired, setscrews 100A, 100B can have an overall length dimension that is less than the sidewall thickness dimension of nut 10, and thus, less than the length dimension of setscrew bore 50. Such configuration enables the setscrews 100A, 100B to be housed entirely in the nut 10 sidewall thickness while the nut 10 is being installed upon fastener 8. In other implementations, the length of one or more of setscrews 100A, 100B is greater than the sidewall thickness of nut 10, when it is desired for the setscrew(s) 100A, 100B to protrude outwardly beyond sidewall 16 during use.

The tool engaging ends 140 include structure(s), projections or recesses, configured to suitably interface with a corresponding tool. For example, tool engaging ends 140 can include recess 145. Recess 145 is any of, e.g., slotted, Phillips, Torx®, hex, spanner, Pozidriv®, and/or other configurations as desired. In any event, recess 145 and the tool required to drive and manipulate setscrew 100A, 100B by way of the recess 145 permit the setscrew 100A, 100B to be driven sub-flush or flush with a sidewall 16 surface, as desired.

Thread engaging end 170 extends from the end of shank 110 that is opposite of tool engaging end 140. The thread engaging end 170 includes a tapering sidewall 172 and an end surface 175. Tapering sidewall 172 decreases in diameter along its length and thereby defines a tapering, conically or otherwise, outer surface. Preferably, the tapering sidewall 172 provides a frusto-conical configuration to the thread engaging end 170. A greatest diameter portion of thread engaging end 170 is defines at the intersection of sidewall 172 and shank 110. From that intersection, the sidewall 172 tapers downwardly as it extends away from the remainder of setscrew 100A, 100B.

Tapering sidewall 172 is the portion of thread engaging end 170 that directly interfaces the threads 30 of fastener 8. When viewing the tapering sidewall 172 in profile, it has upper and lower, straight line, linear, segments that extend toward a common point. Such linear segments can have lengths corresponding to the length dimensions of the lateral wall segments 36, 38 of thread valleys 34 in fasteners 8. Furthermore, the angle between such upper and lower linear segments of tapering sidewall 172 corresponds to the angle between the lateral wall segments 36, 38 of thread valleys 34 in fasteners 8.

As such, the thread valleys 34 and the tapering sidewall 172 have outer profiles which correspond to each other, whereby the thread engaging end 170 can selectively nest within and interface the thread valleys 34 of fasteners 8. Preferably, the interfacing relationship is defined along a major portion of the lengths of each of the tapering sidewall 172, and the lateral wall segments 36, 38 of thread valleys 34.

When viewed in cross-section as the tapering sidewall 172 interfaces the thread valley 34, a major portion of the void space defined within the thread valley 34 is occupied by the thread engaging end 170. In some implementations, the diameter of the widest portion of the thread engaging end 170 is smaller in magnitude than that of the peak-to-peak distance between adjacent thread peaks 32. Correspondingly, during use, in such implementations, no part of the setscrew 100A, 100B contacts the apexes of thread peaks 32, mitigating the likelihood of radial compression-type thread battering or other damage to threads 30.

In this configuration, the thread engaging end 170 wedges into the thread valleys 34, similar to the relationship between corresponding portions of threads 30 and 40, in their cooperating engagement. When the setscrews 100A, 100B are left sufficiently loose, the thread engaging ends 170 mimic the thread profiles of threads 40 in bores 20. Therefore, threads 30 slidingly interface with thread engaging ends 170 and helically pass over them, whereby fasteners 8 or nuts 10 can be generally freely rotated, analogous to how they pass over the remainder of threads 40.

When the setscrews 100A, 100B are suitably tightened or loaded, they each frictionally engage the first and second converging lateral wall segments 36, 38, preventing non-desired rotation of fastener 8 and nut 10. During such locked engagement with fastener 8, each of the setscrews 100A, 100B translates its respective loading force into the first and second converging lateral wall segments 36, 38 as both an axially directed force component and a radially directed force component.

Due to the frusto-conical shape of tapering sidewall 172, and the closely corresponding angles of the various interfacing surfaces of tapering sidewall 172 and thread valley 34, they interface each other through a relatively large surface area or contact patch. Accordingly, since the forces translate through relatively large contact patches or surface areas between the tapering sidewall 172 and thread valley 34, the force per area is sufficiently dissipated to mitigate the likelihood of delivering localized pressure induced damage to the threads 30.

The end surface 175 of the thread engaging end 170 is generally planar and perpendicular to the axis of the setscrews 100A, 100B. End surface 175 defines the least diameter portion of thread engaging end 170, and typically also has a smaller diameter than shank 110. As desired, the end surface 175 can include a void or depression 178. Depression 178 can be a cylindrical, conical, or other recess extending through the end surface 175, and axially into the thread engaging end 170. In such implementations, the end surface 175 appears as an annular configuration in lieu of a circular, planar one as it is when devoid of the depression 178.

Depression 178 can be implemented when it is desired to greatly mitigate the likelihood of damaging threads 30. In such implementations, tapering sidewall 172 circumferentially surrounds the depression 178, whereby the tapering sidewall 172 has a thinner sidewall thickness dimension as compared to implementations having a continuously solid thread engaging end 170. Accordingly, a tapering sidewall 172 in embodiments with depression 178 are relatively more likely to yield, give way, flex, deform, or otherwise distort when the setscrew 100A, 100B is subjected to loading or locking forces. In other words, depression 178 enables thread engaging end 170 to compress or distort before threads 30, ensuring the integrity of threads 30 is maintained during use of reusable lock nut device 5.

In light of the above, to use the reusable lock nut device 5, the user selects the appropriately sized nut 10 to fit the particular fastener 8. Setscrews 100A, 100B are at least partially threaded or inserted into the setscrew bores 50, extending through the respective nut sidewalls 16. As desired, the length of setscrews 100A, 100B can be less than the thickness dimension of the nut sidewalls 16, whereby the tool engaging end 140 can be axially advanced sufficiently far into setscrew bore 50 so that it is flush or sub-flush with the outwardly facing surface of the respective sidewall 16, whilst the thread engaging end 170 does not yet contact the fastener 8.

As seen in FIG. 4, if the setscrews 100A, 100B are sufficiently short, the nut 10 can be threadedly or otherwise manipulated upon fastener 8, as if nut 10 were conventional, even though it includes setscrews 100A, 100B extending therethrough. All the while, the setscrews 100A, 100B are temporarily housed within the sidewall 16 thickness, between the sidewall 16 and the bore 20. In other words the setscrews 100A, 100B can be sub-flush the sidewalls 16, yet not lock into the fastener 8, whereby a tool, e.g., a socket wrench, a boxed end wrench, or other appropriate tool, can be used on the outer perimeter of the nut 10 without interference from the setscrew 100A, 100B. The nut 10 is then adjusted to the desired axial position upon fastener 8.

In particular, the appropriate tool head is inserted into the recess 145 of tool engaging end 140. The tool is manipulated which rotates the setscrew 100A, 100B in the desired direction of rotation. While the setscrew 100A, 100B rotates, its threads 120 operatively engage threads 60 of setscrew bores 50, axially advancing the setscrew 100A, 100B through the respective setscrew bore 50.

Once the setscrews 100A, 100B advance sufficiently far through the setscrew bores 50, the thread engaging ends 170 contact the threads 30 of fastener 8. At this point, the user can recheck the position of nut 10 with respect to fastener 8. If the setscrews 100A, 100B are only lightly, slightly, or otherwise minimally engaging the threads 30 of fastener 8, the user can still rotate the nut 10, without compromising the integrity of the threads 30. As heretofore described, this is possible since the thread engaging end 170 mimics the threads 40 of bore 20 when the setscrews 10A, 100B engage the threads 30 with insufficient force to frictionally prevent fastener 8 or nut 10 from rotating.

Once the position of nut 10 is rechecked or confirmed with respect to fastener 8, the setscrews 100A, 100B are then tightened to engage threads 30 with sufficient force to lock fastener 8 and nut 10 with respect to each other. In particular, as each setscrew 100A, 100B axially advances through bore 50, the frusto-conically tapering sidewall 172 urges into a nested interface with the respective thread valley 34. This mechanical interference and frictional engagement prevents non-desired rotation of fastener 8 and/or nut 10.

While the invention has been shown and described with respect to particular embodiments, it is understood that alternatives and modifications are possible and are contemplated as being within the scope of the present invention. A wide variety of fasteners, shafts, and/or other hardware can employ the reusable lock nut device 5 of the present invention. In addition, it should be understood that, e.g., the relative lengths, sizes, or number of setscrews 100A, 100B employed on nut 10 is not limiting on the invention.

Many changes and modifications could be made to the invention without departing from the spirit thereof. The scope of these changes will become apparent from the appended claims.

We claim:

1. A reusable locknut device, comprising:
a nut having first and second ends, a bore extending axially between the first and second ends, multiple sidewalls extending about and defining an outer perimeter of the nut, and a setscrew bore extending radially between a sidewall and the axial bore; and
a setscrew having a shank, a tool accepting end, and a thread engaging end, the thread engaging end defining a frusto-conical outer surface and a depression extending axially thereinto.

2. The reusable locknut device as in claim 1, wherein the thread engaging end defines a length and the depression extends along a major portion of such thread engaging end length.

3. The reusable locknut device as in claim 2, wherein the depression extends along the entirety of such thread engaging end length.

4. The reusable locknut device as in claim 1, wherein the depression is generally cylindrical.

5. The reusable locknut device as in claim 1, wherein the depression is generally conical.

6. The reusable locknut device as in claim 1, wherein the thread engaging end includes a circumferential sidewall extending about the perimeter of the depression.

7. The reusable locknut device as in claim 1, wherein the shank and the tool accepting end define generally equivalent diameters.

8. The reusable locknut device as in claim 1, wherein the frusto-conical outer surface tapers downwardly from a relatively larger diameter portion proximate the shank to a relatively lesser diameter portion distal the shank.

9. A reusable locknut device for use with a threaded fastener having thread valleys defined between respective pairs of converging lateral wall segments on its outer circumferential surface, comprising:
a nut having an axial bore accepting the threaded fastener therethrough and at least one setscrew bore extending radially through the nut and opening into the axial bore;
a setscrew received in the setscrew bore and having an elongate shank extending between a tool accepting end and a thread engaging end,
wherein the setscrew thread engaging end is tapered, defining a taper angle corresponding in magnitude to a magnitude of an angle defined between a pair of converging lateral wall segments of the thread valley upon the threaded fastener.

10. The reusable locknut device as in claim 9, wherein the setscrew thread engaging end occupies a major portion of a void defined by the thread valley, when viewed in cross-section.

11. The reusable locknut device as in claim 9, wherein the setscrew thread engaging end nests substantially within the thread valley.

12. The reusable locknut device as in claim 9, wherein the thread valley includes first and second converging sidewalls and the setscrew thread engaging end contacts both of the first and second converging sidewalls.

13. The reusable locknut device as in claim 9, wherein the thread valley defines a valley depth dimension, the setscrew thread engaging end extending into the thread valley, along a major portion of the valley depth dimension.

14. The reusable locknut device as in claim 9, wherein the thread valley defines a valley depth dimension and the setscrew thread engaging end a length dimension, the length dimension corresponding in magnitude to a magnitude of the valley depth dimension.

15. The reusable locknut device as in claim 9, wherein the taper angle is about 60 degrees.

16. A reusable locknut device, comprising:
a nut having an axially extending threaded bore and a setscrew bore opening into the threaded bore;
a threaded fastener extending into the threaded bore and defining alternating thread peaks and thread valleys, the thread valleys having first and second converging lateral wall segments extending angularly from a point of intersection with each other, toward adjacent thread peaks; and
a setscrew received in the setscrew bore and having a shank, a tool accepting end, and a tapered thread engaging end for interfacing the threads of a piece of hardware, the tapered thread engaging end engaging each of the first and second converging lateral wall segments of the thread valleys.

17. The reusable locknut device as in claim 16, wherein the thread engaging end includes a depression extending thereinto.

18. The reusable locknut device as in claim 16, wherein the thread engaging end interfaces the thread valley by way of an elongate contact patch.

19. The reusable locknut device as in claim 16, wherein the setscrew transfers forces radially and axially into the threads of the threaded fastener.

20. The reusable locknut device as in claim 16, wherein the thread engaging end includes a frusto-conical outer surface and a depression extending axially thereinto.
